(19) United States
(12) Patent Application Publication
(10) Pub. No.: US 2014/0162506 A1
(43) Pub. Date: Jun. 12, 2014

(54) ELECTRICAL CONTACT COATING

(71) Applicants: Olivier De Cloet, Lorsch (DE); Helge Schmidt, Speyer (DE); Volker Seipel, Bensheim (DE)

(72) Inventors: Olivier De Cloet, Lorsch (DE); Helge Schmidt, Speyer (DE); Volker Seipel, Bensheim (DE)

(73) Assignee: Tyco Electronics AMP GmbH, Bensheim (DE)

(21) Appl. No.: 14/127,965

(22) PCT Filed: Jun. 21, 2012
(86) PCT No.: PCT/EP2012/061999

§ 371 Date: Dec. 19, 2013

(30) Foreign Application Priority Data
Jul. 1, 2011 (DE) 102011078546.9

(51) Int. Cl. H01B 1/02; H01R 13/03

(52) U.S. Cl. CPC H01B 1/02; H01R 13/03
USPC 439/886; 174/126.2

(57) ABSTRACT

The invention relates to an electrical contact coating for an electrically conductive substrate, preferably a substrate made of copper, a copper-based alloy or a copper-plated substrate in particular for a high-temperature application in an electric or hybrid motor vehicle, with a layered arrangement which can be applied to the substrate and which has two layers, the one layer comprising a transition metal and the other layer a noble metal, with an intermediate layer being provided between the two layers of the layered arrangement, which intermediate layer comprises copper, and one of the two layers being an outer layer. Further, the invention relates to an electrical or electromechanical contact element for a high-temperature application, to an electrical, electronic and/or electro-optical connector, and to the use of copper or a layer comprising copper for a coating, in particular an electrical contact coating, preferably for high-temperature applications.

The invention relates to an electrical contact coating for an electrically conductive substrate, preferably a substrate made of copper, a copper-based alloy or a copper-plated substrate, in particular for a high-temperature application in an electric or hybrid motor vehicle. Further, the invention relates to an electrical or electromechanical contact element for a high-temperature application, in particular for the high-voltage or automotive sector. Furthermore, the invention relates to an electrical, electronic and/or electro-optical connector, in particular a plug-in connector or a connection means for high-temperature applications, in particular in the high-voltage and/or high-current sector. Furthermore, the invention relates to the use of copper or a layer comprising copper for a coating, in particular an electrical contact coating, preferably for high-temperature applications.

In electrical engineering and electronics, a large number of electrical socket and/or pin connectors—referred to below as electrical (plug-in) connectors, mating (plug-in) connectors or (mating) connection means—are known which serve to transmit electric currents, voltages and/or signals with a maximum possible range of currents, voltages, frequencies and/or data rates. In particular in the automotive sector and in the high-voltage or high-current sector, such connectors have to guarantee, for a short time and/or permanently, perfectly satisfactory transmission of electric power, signals and/or data in warm, possibly hot, polluted, moist and/or chemically aggressive environments. Owing to the wide range of applications for such connectors, a large number of specially configured socket connectors and/or pin connectors are known.

Such electrical connectors or their housings may be provided on an electric line, a cable, a cable harness or an electrical means, such as on/in a housing or on a printed circuit board of an electrical or electronic apparatus; in the latter case, usually the term “(mating) connection means” is used. If a connector is located on a line or a cable, usually the term “flying (plug-in) connector” or “plug” or “coupling” is used; if it is located on/in an electrical/electronic means, usually the term “integrated plug” or “(integrated) bush” is used. Further, a mating connector is often also referred to as a plug receptacle, especially when the mating connector has a supporting collar which is intended to ensure a more robust connection between the plug-in connector and the mating connector, i.e. the plug receptacle. In the field of high-voltage and high-current technology, in the field of the relevant connections, usually the terms “cable fittings” and “male cable connectors” are used.

Thus, connectors or couplings which supply batteries with electric current are required e.g. for an electric charging station and/or onward electrical power contacting in an electric or hybrid vehicle. Thus for example electrical connectors for supply units, such as a wall box in a garage, on a carport or a wall region, or charging points for electric and hybrid vehicles are required, by means of which the batteries of the motor vehicle can be topped-up with electricity. For this, the electrical connector, which may possibly be mechanically stressed in the region of its contact elements, again has to be able to be connected permanently and securely, and at elevated temperatures has to ensure perfectly satisfactory transmission of the electric charging current and other electrical or electronic signals for controlling the charging operation of the battery or batteries.

Transmission of data is further becoming increasingly important, with high demands in terms of data transmission being a crucial component of virtually every branch of industry, such as the computer industry or the automobile industry. Here, in addition to electrical connectors, wide product ranges of electro-optical connectors are required which have to ensure high data transfer rates even at relatively high and high temperatures. Thus, for example, in a motor vehicle entertainment and infotainment information is exchanged electrically and possibly also via an optical bus. For these and also other electrical and/or optical data-transmission technologies, connectors or connection means are required which permanently and securely couple or connect the electrical and/or optoelectronic components together electrically and/or optically.

High endurance at elevated temperatures is also required for cable accessories for electrical voltages above 1 kV. Thus, in the case of cable connections or cable fittings which in particular are not SF₆-gas-insulated, care has to be taken that the electrical properties of the electrical contacting regions thereof do not change, or change only slightly, over time, with effective electrical connections which are permanently secure over the years having to be set up between the connection means involved. Electric cable fittings for medium-voltage and high-voltage applications, such as for example shielded (right-angle) plugs and adapter (plug-in) connectors, have, within a fitting body, usually one electrical contact means formed as a threaded pin or a contact pin, which means is in electrical and mechanical contact with a conductor connection of a high-voltage cable.

For a good electrical transition between a connector and a mating connector which is complementary thereto, the connector and/or the mating connector often have coated contact elements. Such a contact coating is usually made from silver on the outside owing to its excellent electrical conductivity, and has a nickel layer underneath it. At relatively high or high temperatures, which may exceed 180-200° C., the contact coatings of such contact elements tend to delaminate after a certain time. This occurs owing to the diffusion of atmospheric oxygen through the silver layer to the nickel layer, with the nickel layer being oxidised, which leads to the delamination, i.e. detachment, of the silver layer from the nickel layer. This may be the case with current layer thicknesses for connectors of electric or hybrid motor vehicles e.g. at temperatures of approximately 180° C. after only 200 hours.

US 2009/0017327 A1 discloses a leadframe for electrically contacting an integrated circuit and an electromechanical contact element for point contacts made of copper. In order to avoid corrosion of the copper, the leadframe and the contact element in each case have an outer corrosion protection layer of tin, with a barrier layer of nickel being provided to prevent interdiffusion between the copper substrate and the tin layer. In order to prevent whiskering of the tin on the leadframe, a layer of silver is provided between the copper substrate and the layer of tin. In order to prevent fretting corrosion in the contact element, a sacrificial layer, of copper, and on this an oxide layer, is provided on the nickel barrier layer, which oxide layer may consist of silver oxide.

It is an object of the invention to devise an improved electrical contact coating, an improved electrical or electromechanical contact element and hence also an improved electrical, electronic and/or electro-optical connector for high-temperature applications, in particular in the high-voltage and/or high-current sector, inter alia for electric or hybrid motor vehicles. In so doing, delamination of an electrical contact coating should be effectively prevented permanently even at high or relatively high temperatures of at least 150 to over 200° C. In so doing, the contact coating should be able to be provided on the contact element of the connector simply, rapidly and inexpensively. Further, it is an object of the invention to devise a use of copper or a layer comprising copper for a coating, in particular an electrical coating, for high-temperature applications.

The object of the invention is achieved by means of an electrical contact coating for an electrically conductive substrate in particular for a high-temperature application in an electric or hybrid motor vehicle, according to Claim 1; by means of an electrical or electromechanical contact element for a high-temperature application, according to Claim 7; by means of an electrical, electronic and/or electro-optical connector, in particular a plug-in connector or a connection means in the high-voltage and/or high-current sector, according to claim 9; and by the use of copper or a layer comprising copper for a coating, in particular an electrical contact coating, according to Claim 11. Advantageous developments, additional features and/or advantages of the invention will become apparent from the dependent claims and the following description.

The electrical contact coating according to the invention or the composite material according to the invention has a layered arrangement which can be applied to a substrate, which arrangement comprises at least two layers, the one layer being a transition metal and the other layer being a noble metal. Between the two layers of the layered arrangement there is provided a third layer, what is called an intermediate layer, which according to the invention comprises copper. In such case, one of the two layers is preferably an electrically contactable outer layer which is accessible to a contact element of a mating connector.—The electrical or electromechanical contact element according to the invention comprises an outer layer and an inner layer, the outer layer comprising a noble metal and the inner layer a transition metal. According to the invention, an intermediate layer is provided between the outer layer and the inner layer of this layered arrangement, which intermediate layer. comprises copper.

The electrical, electronic and/or electro-optical connector according to the invention has an electrical contact coating according to the invention provided on a substrate of the connector and/or an electrical or electromechanical contact element according to the invention. The connector may in this case be designed as a socket connector, pin connector or hybrid connector e.g. for plug-in connections in the automotive sector, or as a cable fitting or a male cable connector for medium-voltage and/or high-voltage cables or lines. Further, the connector may be designed as an electrical or electromechanical contact element as a pad, a tab or at least a section of a printed conductor of a printed circuit board.—When using copper or a layer comprising copper according to the invention, it is used as a direct backing or a direct underlayer for a layer, in particular an outer layer, which comprises a noble metal or is a noble-metal layer.

According to the invention, the transition-metal layer is designed as a barrier layer, the noble-metal layer as an electrical contacting layer and/or the intermediate layer as an anti-diffusion layer. In such case, the transition-metal layer is an inner layer and the noble-metal layer an outer layer of the electrical contact coating. The transition metal preferably comprises nickel, but may however also comprise cobalt, iron, manganese, chromium and/or molybdenum or an alloy thereof. The noble metal preferably comprises silver, but may however also comprise gold and/or a platinoid. That is to say that according to the invention the inner layer comprises in particular nickel or a nickel-based alloy, and the outer layer comprises in particular silver or a silver-based alloy.

According to the invention, the copper layer hinders the diffusion of atmospheric oxygen as far as the inner layer, which preferably comprises nickel, the intermetallic properties of the electrical contact coating being improved. This, according to the invention, effectively prevents delamination of the contact coating permanently even at high or relatively high temperatures of at least 150 to 200° C. That also means that when the invention is used in a plug-in connector the extraction forces of the plug-in connector permanently remain substantially constant, since they are not increased by delamination of the contact coating.

When a lubricant is used, this means that the plugging/traction forces can be set permanently for a particular range. Further, the additional layer of the contact coating can be provided simply, rapidly and inexpensively on the inner layer and in terms of time before the outer layer on a contact element of a connector.

According to the invention, the intermediate layer can lie directly on the outer layer and/or directly on the inner layer of the contact coating, and is, optionally in each case, electrically connected thereto. Further, according to the invention the layered arrangement of the electrical contact coating may have a fourth layer which is arranged between the substrate and the inner layer. In such case, the fourth layer is designed in particular as a base layer or adhesion layer which preferably comprises copper or a copper-based alloy. That is to say, further, that the layered arrangement, apart from the base layer which is optionally present, preferably comprises exactly three layers. In such case, according to the invention a predominant proportion by weight or by volume of the outer layer is a noble metal. A predominant proportion by weight or by volume of the inner layer in such case is a transition metal, in particular nickel, and a predominant proportion by weight or by volume of the base layer and/or the intermediate layer is copper.

In preferred embodiments of the invention, the intermediate layer and/or the base layer is a copper flash or a copper strike. The substrate itself may in such case comprise copper or a copper-based alloy, or be a copper-plated substrate. However, also other materials, in particular electrically conductive materials, are suitable for the substrate. The substrate itself may in such case serve for contacting on its own, or even may be provided again on a backing, such as a component. According to the invention, the layered arrangement can be applied over the surface and/or selectively to the substrate. In particular, the layered arrangement can be provided on/in an electrical contacting region of the electrical contact element or the electrical connector. In such case, the substrate is at least a region of the contact element or of the connector.

The invention will be explained in greater detail below using examples of embodiment with reference to the appended drawings. The two highly abstract figures of the drawings, which are not to scale, show:

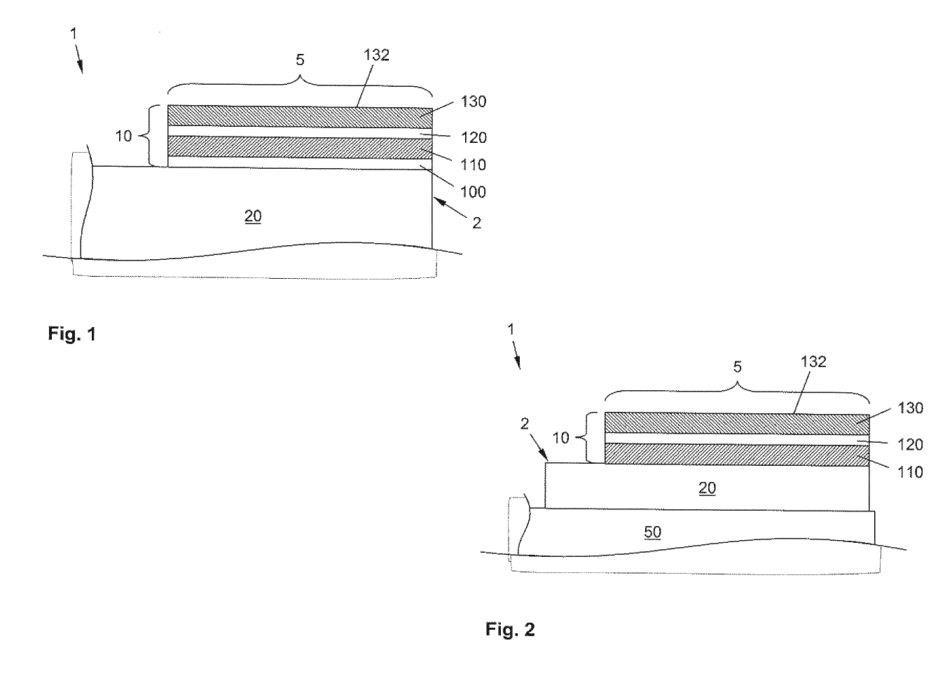

FIG. 1 in a sectional side view, a first embodiment of an electrical contact coating according to the invention on an electrically conductive substrate of an electrical, electronic and/or electro-optical connector; and

FIG. 2 in a view analogous to FIG. 1 a second embodiment of the invention, the substrate being provided with the electrical contact coating according to the invention on an electrical or electronic component.

The invention will be explained in greater detail below, initially generally with reference to an electrical, electronic and/or electro-optical connector 1, the drawing being kept correspondingly diagrammatic. The connector 1 may in such case be designed as a plug-in connector 1 or a connection means 1 preferably for a high-voltage/high-current (plug-in) connection. In such case, the connector) may be designed as a socket connector 1, pin connector 1 or hybrid connector 1 for plug-in connections in the automotive sector, in particular for electric or hybrid motor vehicles, in the electrical engineering sector and/or in the field of medium-voltage or high-voltage cables, or for example as a pad 1, a tab 1 or a section of a printed conductor 1 of a printed circuit board 50 (see FIG. 2) or as a leadframe 1.

Such a connector 1 is designed e.g. as a socket connector 1 and/or pin connector 1, as a (flying) coupling 1, as an (integrated) plug), as an (integrated) bush), as a socket receptacle 1 and/or plug receptacle 1, as a header 1, as an interface 1, as a contact insert 1, as a contact carrier 1, as a cable fitting 1, as a male cable connector 1, as a base connector/plug 1, as a coupling connector/plug 1, as a sleeve 1, as a cable connection plug 1, as a (shielded) (right-angle) plug 1, as an adapter (plug-in) connector 1, as a (cable) sealing end 1, etc.

In this case, the connector 1 has an electrical or electromechanical contact element 2. The contact element 2 in such case serves for power contacting and/or signal contacting, the contact element 2 possibly being designed e.g.: as a (high-current/high-voltage) contact means 2, as a socket contact means 2, as a pin contact means 2, as a connection 2, as a connecting pin 2, as a pad 2, as a tab 2, as a printed conductor 2, as a grid 2, as a power contact 2, as a signal/data contact 2, as a threaded pin 2, as a contact pin 2, as a crimp contact 2, as a hermaphroditic connector 2, as a knife-blade contact 2, as a forked contact 2, as an insulation-displacement contact 2, as a spring contact 2, as a spring clamping means 2, as a plug-in receptacle 2, as a quick-connect receptacle 2, as an insertion tongue 2, as a plug-in pin 2, as a conductor 2, as a flat conductor 2, as electromagnetic shielding 2 etc.

At least in one electrical contacting region 5 of the contact element 2 or of the connector 1, the contact element 2 has an electrical contact coating 10 according to the invention on a substrate 20, which in turn can be arranged on a backing 50 (see FIG. 2). The contacting region 5 can be electrically contacted on its outer electrical contact surface 132 by a contact element of a mating connector.

In such case, the backing 50 may be an electrical or electronic component 50, a printed circuit board 50, a printed board 50 etc. It is of course possible to use the substrate 20 as the final support for the contact coating 10 (see FIG. 1). This is the case in particular with conventional socket contact means 2 and pin contact means 2. In this case, the substrate 20 itself may in turn have a layered structure.

The substrate 20 is preferably made from an electrically conductive material, such as for example copper, in particular OF/OFHC copper (OF: oxygen-free, OFHC: oxygen-free high conductive). Of course, another electrically conductive material, in particular a metal or a metal alloy, can also be used instead of copper; in such a case, preferably a base layer 100 is used. That is to say that in preferred embodiments of the invention a layer 100, preferably formed as an adhesion layer 100 or base layer 100, which comprises in particular copper or a copper-based alloy, is used as the lowermost layer 100 of the contact coating 10. In such case, a copper flash or a copper strike is preferred.

The layered arrangement 10 according to the invention of the electrical contact coating 10 has, apart from the base layer 100, preferably exactly three layers 110, 120, 130, namely an inner layer 110, an intermediate layer 120 and an outer layer 130. In this case, the inner layer 110 is designed as a barrier layer 110, an intermediate layer 110 or a transition-metal layer 110. The intermediate layer 120 is an underlayer, formed as an anti-diffusion layer 120 or as a barrier layer 120, for the outer layer 130 of the layered arrangement 10. Finally, the outer layer 130 is designed as an electrical contacting layer 130 or as a noble-metal layer 130.

The inner layer 110 preferably comprises nickel or a nickel-based alloy, but may also comprise e.g. cobalt, iron, manganese, chromium, molybdenum or an alloy based thereon. The intermediate layer 120 comprises copper or a copper-based alloy, and is again designed in particular as a copper flash or a copper strike. The outer layer 130 preferably comprises metallic silver or a metallic silver-based alloy, but may also comprise e.g. metallic gold or a metallic platinoid. Further, the outer layer 130 may be a metallic palladium/nickel/gold layer, in particular a palladium/nickel flash/gold coating.

In such case, a metal oxide layer, in particular a noble-metal oxide layer, is to be understood not to be a layer which contains the metal in question; such layer merely contains the metal oxide, which differs greatly in its properties. That is to say, for example, that silver oxide is a distinct substance, as is silver too, hence silver oxide does not comprise any atomic silver.

The invention is of course not limited to the above examples of connectors 1 or contact elements 2, but can be used anywhere where coatings, in particular contact coatings, tend to delaminate, which may be the case in particular at elevated temperatures, i.e. at temperatures of over 20-80° C. In such case, then instead of a conventional coating the coating according to the invention can be provided, or the copper layer according to the invention can be provided between a noble metal/nickel layer sequence.

The base layer 100, the inner layer 110, the intermediate layer 120 and/or the outer layer 130 may for example be electrodeposited by means of electroplating. They may further be vapour-deposited, sputtered or provided by epitaxial growth. Preferred methods, in addition to electroplating, are chemical vapour deposition (CVD), physical vapour deposition (PVD), plasma-supported chemical vapour deposition (PECVD: plasma-enhanced chemical vapour deposition, PACVD: plasma-assisted chemical vapour deposition), metallic spray-coating (metal spraying), electroless deposition, such as dip-plating, or chemical deposition.

The layer thicknesses of the base layer 100, the inner layer 110, the intermediate layer 120 and/or the outer layer 130 may generally lie in a range from 0.01 μm to over 200 μm, depending on the field of application. In this case, it is preferable for the base layer 100 and the intermediate layer 120 to be designed as comparatively thin layers 100, 120, these preferably being able to be designed as a copper flash or a copper strike. Here then the layer thicknesses are preferably 0.05-2 μm, in particular 0.2-1 μm. It is of course possible optionally to apply in particular the copper layer 120 designed as a barrier layer or anti-diffusion layer 120 by means of other methods, the layer thicknesses lying preferably in a range from 3-20 μm, in particular 2-15 μm, and preferably 1-10 μm.

In applying the invention to an electromechanical contact element, such as for example a high-voltage and/or high-current connector 1 for electric or hybrid vehicles, the outer layer 130, which preferably consists predominantly of silver, has a layer thickness of 2-15 μm, in particular 1-10 μm, preferably of 0.5-5 μm and particularly preferably of 0.8-2.5 μm. In this case, the silver layer 130 may consist of bright pure silver or of hard silver. When using gold as the outer layer 130, a layer thickness of 0.7-0.9 μm±0.1 μm is preferred. The inner layer 110, which is designed as a barrier layer 110, in such case preferably has a layer thickness of 0.02-5 μm, in particular 0.05-2 μm. Other layer thicknesses can of course be used, depending on the demands made on the relevant electrical contacting region(s) 5 of the electrical or electromechanical contact element(s) 2 of the connector 1.

1-11. (canceled)

12. An electrical contact coating for an electrically conductive substrate, preferably a substrate made of copper, a copper-based alloy or a copper-plated substrate, in particular for a high-temperature application in an electric or hybrid motor vehicle, with a layered arrangement which can be applied to the substrate and which has two layers, the one layer comprising a transition metal and the other layer a noble metal, wherein an intermediate layer is provided between the two layers of the layered arrangement, which intermediate layer comprises copper, and one of the two layers is an outer layer.

13. The electrical contact coating according to claim 12, wherein the one layer is designed as a barrier layer, the other layer as an electrical contacting layer, and/or the intermediate layer as an anti-diffusion layer.

14. The electrical contact coating according to claim 12, wherein the transition-metal layer is an inner layer and the noble-metal layer is the outer layer,
the transition metal preferably comprising nickel, cobalt, iron, manganese, chromium and/or molybdenum or an alloy thereof, and/or
the noble metal preferably comprising silver, gold and/or a platinoid, the inner layer comprising in particular nickel or a nickel-based alloy, and the outer layer comprising in particular silver or a silver-based alloy.

15. The electrical contact coating according to claim 12, wherein the intermediate layer lies directly on the outer layer and/or directly on the inner layer and is, optionally in each case, electrically connected thereto.

16. The electrical contact coating according to claim 12, wherein the layered arrangement has a fourth layer which is provided between the substrate and the inner layer, the fourth layer being formed as a base layer or adhesion layer, which preferably comprises copper or a copper-based alloy.

17. The electrical contact coating according to claim 12, wherein:
the layered arrangement, apart from the base layer which may optionally be present, comprises exactly three layers;
a predominant proportion by weight or by volume of the outer layer is a noble metal;
a predominant proportion by weight or by volume of the inner layer is a transition metal, in particular nickel;
a predominant proportion by weight or by volume of the base layer and/or the intermediate layer is copper;
the intermediate layer and/or the base layer is a copper flash or a copper strike;
the substrate comprises copper or a copper-based alloy, or is a copper-plated substrate;
the layered arrangement can be applied over the surface and/or selectively to the substrate;
the layered arrangement can be provided in an electrical contacting region of the electrical contact element or the electrical connector; and/or
the substrate is at least a region of an electrical contact element or an electrical connector.

18. An electrical or electromechanical contact element for a high-temperature application, in particular for the high-voltage or automotive sector, with an outer layer and an inner layer, the outer layer comprising a noble metal and the inner layer a transition metal, wherein an intermediate layer which comprises copper is provided between the outer layer and the inner layer.

19. The electrical or electromechanical contact element according to claim 18, wherein an intermediate layer is provided between the two layers of the layered arrangement, which intermediate layer comprises copper, and one of the two layers is an outer layer.

20. An electrical, electronic and/or electro-optical connector, in particular a plug-in connector or connection means for high-temperature applications, in particular in the high-voltage and/or high-current sector, with an electrical contact coating according to claim 12 provided on a substrate.

21. The electrical, electronic and/or electro-optical connector according to claim 20, wherein:
the connector is designed as a socket connector, pin connector or hybrid connector for plug-in connections in the automotive sector;
the connector or the electrical or electromechanical contact element is designed as a pad, a tab or at least a section of a printed conductor of a printed circuit board; or
the connector is formed as a cable fitting or a male cable connector for medium-voltage or high-voltage cables.

22. An electrical, electronic and/or electro-optical connector, in particular a plug-in connector or connection means for high-temperature applications, in particular in the high-voltage and/or high-current sector, with an electrical or electromechanical contact element according to claim 18.

23. The electrical, electronic and/or electro-optical connector according to claim 22, wherein:
the connector is designed as a socket connector, pin connector or hybrid connector for plug-in connections in the automotive sector;
the connector or the electrical or electromechanical contact element is designed as a pad, a tab or at least a section of a printed conductor of a printed circuit board; or
the connector is formed as a cable fitting or a male cable connector for medium-voltage or high-voltage cables.

24. The use of copper or a layer comprising copper for a coating, in particular an electrical contact coating, preferably for high-temperature applications, wherein the copper or the layer comprising copper serves as a direct backing or a direct underlayer for a layer, in particular an outer layer, which comprises a noble metal or is a noble-metal layer.
